(19) United States
(12) Patent Application Publication
(10) Pub. No.: US 2021/0003763 A1
(43) Pub. Date: Jan. 7, 2021

(54) LIGHT-GUIDING PLATE, AND HOLOGRAM RECORDING DEVICE AND HOLOGRAM RECORDING METHOD USED FOR THE SAME

(71) Applicant: Hitachi-LG Data Storage, Inc., Tokyo (JP)

(72) Inventors: Mayumi SASAKI, Tokyo (JP); Takeru UTSUGI, Tokyo (JP)

(21) Appl. No.: 16/849,010

(22) Filed: Apr. 15, 2020

(30) Foreign Application Priority Data
Jul. 4, 2019 (JP) 2019-125130

(51) Int. Cl. F21V 8/00; G02B 5/32; G03H 1/04

(52) U.S. Cl. CPC G02B 6/005; G02B 5/32; G03H 1/0402; G03H 1/0465; G03H 2223/18; G03H 2001/0439; G03H 2001/0441; G03H 2222/31; G03H 2223/20; G02B 6/0025

(57) ABSTRACT

A hologram recording device for producing a hologram that diffracts incident light includes: a laser light source; a first half-wave plate that controls a polarization direction of a light beam emitted from the laser light source; a polarizing beam splitter that reflects S-polarized light to emit the S-polarized light as an “A” light ray and transmits P-polarized light to emit the P-polarized light as a “B” light ray with respect to the light beam passing through the first half-wave plate, and splits the light beam in two directions; a first wedge prism mirror that reflects the “A” light ray; a second half-wave plate that polarizes the “B” light ray into S-polarized light; a second wedge prism mirror that reflects the S-polarized light polarized by the second half-wave plate; and a recording medium irradiated with light rays reflected by the first wedge prism mirror and the second wedge prism mirror.

### CROSS-REFERENCE TO RELATED APPLICATION

The present application claims priority from Japanese application JP2019-125130, filed on Jul. 4, 2019, the contents of which is hereby incorporated by reference into this application.

### BACKGROUND OF THE INVENTION

### 1. Field of the Invention

The present invention relates to a light-guiding plate used for a video display device such as a head mounted display.

### 2. Description of the Related Art

In a video display device such as a head mounted display (HMD), a light-guiding plate is used as an optical system for allowing video light emitted from a projector (video projection unit) to propagate to eyes of a user. Herein, since a volume-type hologram having an optical diffraction function is thin and has characteristics such as wavelength selectivity and angle selectivity, light can be selectively diffracted, and by using volume-type hologram for the light-guiding plate of the HMD, the light-guiding plate that is thin and has a wide field of view (FoV) can be realized.

As a cited document in this technical field, there is JP 2018-526680 W. JP 2018-526680 W discloses a light reflection device called a skew mirror having a reflection axis that does not need to be restricted by a surface normal. The skew mirror is configured to have a substantially constant reflection axis over a relatively wide range of incident angles and discloses a light-guiding plate using a hologram technique, a method of producing the light-guiding plate, and a method of manufacturing the light-guiding plate.

In JP 2018-526680 W, a hologram is recorded by using a mirror. However, a light-guiding plate of an HMD using a volume-type hologram has a problem of color unevenness as a video display device, and the problem is not considered.

### SUMMARY OF THE INVENTION

In view of the above-described problems, the present invention is to realize a light-guiding plate using a volume-type hologram with less color unevenness, a hologram recording device and a hologram recording method used for the light-guiding plate.

In view of the above-described background art and problems, as an example, according to the present invention, there is provided a hologram recording device for producing a hologram that diffracts incident light, including: a laser light source; a first half-wave plate that controls a polarization direction of a light beam emitted from the laser light source; a polarizing beam splitter that reflects S-polarized light to emit the S-polarized light as an “A” light ray and transmits P-polarized light to emit the P-polarized light as a “B” light ray with respect to the light beam passing through the first half-wave plate, and splits the light beam in two directions; a first wedge prism mirror that reflects the “A” light ray; a second half-wave plate that polarizes the “B” light ray into S-polarized light; a second wedge prism mirror that reflects the S-polarized light polarized by the second half-wave plate; and a recording medium which is irradiated with a light ray reflected by the first wedge prism mirror and a light ray reflected by the second wedge prism mirror.

According to the present invention, it is possible to provide a light-guiding plate which can reduce color unevenness of a reproduced image, and a hologram recording device and a hologram recording method used for the light-guiding plate.

### BRIEF DESCRIPTION OF THE DRAWINGS

FIG. 1 is a cross-sectional view of one eye side of a light-guiding plate of an HMD using a volume-type hologram which is a premise of a first embodiment;

FIG. 2 is a schematic explanatory view of a method of manufacturing a volume-type hologram which is a premise of the first embodiment;

FIG. 3 illustrates an optical arrangement in the case of reproducing a volume-type hologram which is a premise of the first embodiment;

FIG. 4 is a configuration view of a volume-type hologram recording device which is a premise of the first embodiment;

FIG. 5 is a flowchart of a volume-type hologram recording process which is a premise of the first embodiment;

FIG. 6 is a view illustrating a relationship among a mirror angle and an incident light diameter/outgoing light diameter of a mirror which is a premise of the first embodiment;

FIG. 7 is a view illustrating a relationship among a light diameter on the recording medium and a recording power density with respect to an interval between the mirror and the recording medium, which is the premise of the first embodiment;

FIGS. 8A to 8C are views describing a basic principle of a wedge prism in the first embodiment;

FIG. 9 is a view illustrating differences of the light diameter and the recording power density on the recording medium with respect to the interval between the mirror and the recording medium in the case of a mirror equipped with the wedge prism in the first embodiment and the case of a mirror in the related art;

FIG. 10 is a configuration view of a volume-type hologram recording device equipped with a wedge prism in the first embodiment;

FIG. 11 is a view describing a state of propagation of light rays to the wedge prism in the first embodiment;

FIG. 12A is a view describing a state of propagation of light rays to the wedge prism in a case where an outgoing angle of outgoing light in the first embodiment is an angle between +ϕ and −ϕ with respect to a central axis of a storage medium;

FIG. 12B is a view describing a state of propagation of light rays to the wedge prism in a case where the outgoing angle of the outgoing light in the first embodiment is an angle of +ϕ with respect to the central axis of the storage medium;

FIG. 12C is a view describing a state of propagation of light rays to the wedge prism in a case where the outgoing angle of the outgoing light in the first embodiment is an angle of −ϕ with respect to the central axis of the storage medium;

FIG. 13 is a configuration view of a volume-type hologram recording device according to a second embodiment; and

FIGS. 14A and 14B are explanatory views of a position/angle adjusting method of a PBS, a wedge prism, or a recording prism and a recording medium according to the second embodiment.

### DETAILED DESCRIPTION OF THE PREFERRED EMBODIMENTS

Hereinafter, embodiments of the present invention will be described with reference to the drawings.

### First Embodiment

First, a light-guiding plate of an HMD using a volume-type hologram (hereinafter, sometimes abbreviated as a skew mirror or simply a hologram), which is a premise of the present embodiment, will be described. Herein, the volume-type hologram is a diffractive optical element in which a three-dimensional (volume) refractive index distribution is formed.

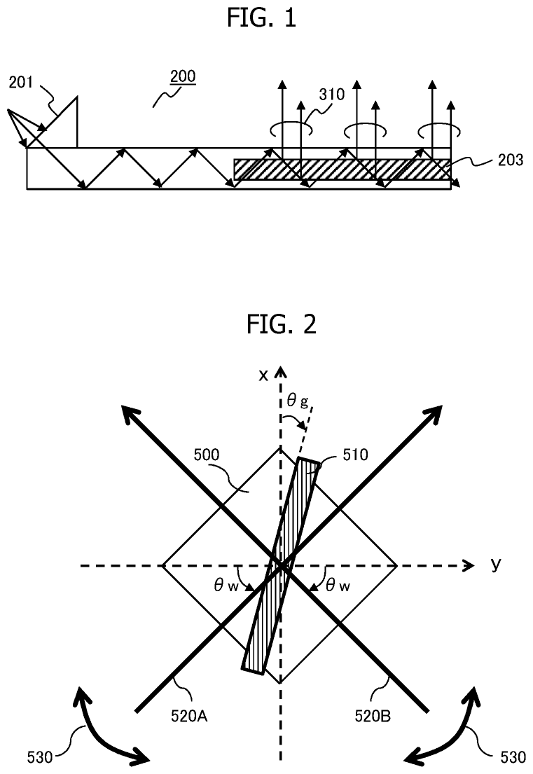

FIG. 1 is a cross-sectional view of one eye side of the light-guiding plate of the HMD using the volume-type hologram.

In FIG. 1, a group of light rays emitted from a video projection unit (not illustrated) is incident on the light-guiding plate 200 through an incident coupler 201. The incident coupler 201 converts the direction of the group of light rays incident on the light-guiding plate into a direction in which the light rays can propagate the light-guiding plate 200 by total reflection. The group of light rays incident on the light-guiding plate 200 propagates by repeating total reflection to be incident on an outgoing coupler 203. The outgoing coupler 203 has a light diffractive portion having characteristics of diffracting a portion of light like a mirror and guiding other light, and a large number of outgoing light ray groups 310 are duplicated in the plane and emitted to reach the eyes of the user.

The incident coupler 201 is configured with a prism, and the volume-type hologram constituting the outgoing coupler 203 is configured with a reflection-type hologram. Hereinafter, a method of manufacturing the volume-type hologram will be described.

FIG. 2 is a schematic explanatory view of the method of manufacturing the volume-type hologram. The volume-type hologram can be produced by recording, as a hologram, interference fringes formed by recording light “A” 520A and recording light “B” 520B emitted from a light source having high coherence such as laser light on a recording medium 510 made of a photopolymer or the like as a photosensitive material. Herein, as illustrated in FIG. 2, a z-axis is defined in a direction perpendicular to an x-axis, a y-axis, and the paper surface. The recording light “A” 520A and the recording light “B” 520B are both parallel lights that are inclined by θw (recording angle) from the y-axis in line symmetry with respect to the x-axis. Thus, the interference fringe plane is formed in parallel to an x-z plane. In addition, the recording medium is inclined by θg from the x-axis. Since the interference fringe plane becomes the reflection plane (skew mirror surface) of the light-guiding plate, θg is the inclination of the reflection plane from the recording medium surface. In addition, the recording prism 500 is used to avoid a reduction in light use efficiency at the time of recording due to surface reflection of the recording medium 510 and an influence of refraction on the recording medium. The recording medium is in a state interposed between the recording prisms.

As indicated by an arrow 530, the recording light “A” 520A and the recording light “B” 520B are rotated by a mirror about the z-axis as a center of rotation, and multiple-recording is performed by changing the angle between the recording lights. Herein, by allowing the recording light to be always in line symmetric with respect to the x-axis, the interference fringe plane can be always in parallel to the x-z plane. Thus, while being fixed in a state of being inclined by θg from the recording medium surface, the interference fringe plane (reflection plane) can be multiple-recorded with a hologram having a different interference fringe pitch.

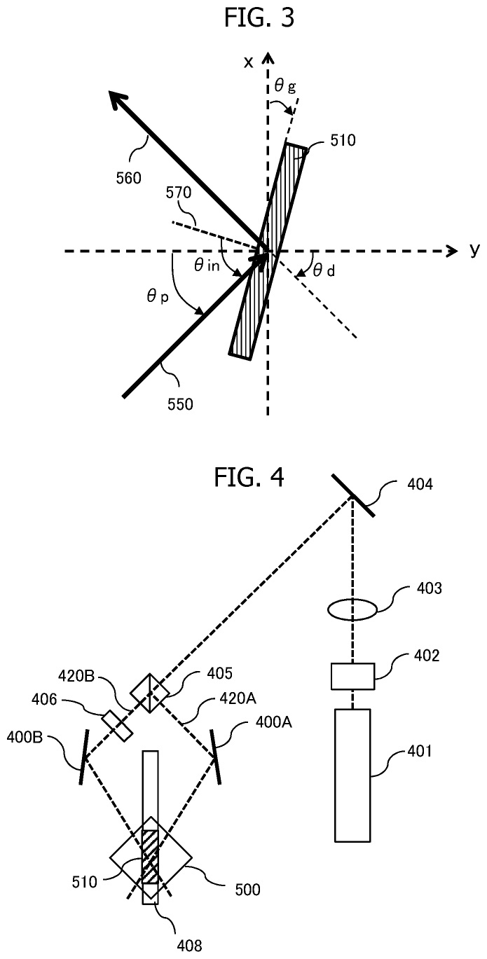

FIG. 3 illustrates an optical arrangement for reproducing a volume-type hologram multiple-recorded by the above-described method. Herein, “reproduction” denotes that the hologram is irradiated with incident light to diffract the light, and the term will be used in this meaning hereafter.

In a case where a reproduction light ray 550 inclined by θp (reproduction angle) from the y-axis direction is incident on the volume-type hologram (the incident angle with respect to the medium is θin=θp+θg, and 570 is a normal to the incident surface of the recording medium 510), and Bragg selectivity is satisfied, the diffracted light 560 is emitted at an angle inclined by θd from the y-axis. In a case where the reproduction light ray has a wide wavelength range corresponding to RGB light and a wide angle range corresponding to the FoV, if the volume-type hologram can be diffracted, the volume-type hologram can be used as an outgoing coupler of the light-guiding plate.

FIG. 4 is a configuration view of the volume-type hologram recording device. The hologram records light by irradiating a recording medium (photopolymer) with light from two directions and allowing the light to interfere. In order to reproduce an image with the light-guiding plate, it is necessary to record a hologram corresponding to a wide range of wavelengths. A hologram corresponding to the above-described wide range of wavelengths can be prepared by changing the mirror angle and performing multiple-recording.

As the positional relationship among the optical components, a polarizing beam splitter (PBS) 405 and the recording medium 510 are located on the same line, and the two mirrors 400A and 400B are located on another same line, and thus, the polarizing beam splitter (PBS) 405, the recording medium 510, and the two mirrors 400A and 400B form a horizontally-and-vertically symmetrical rhombus.

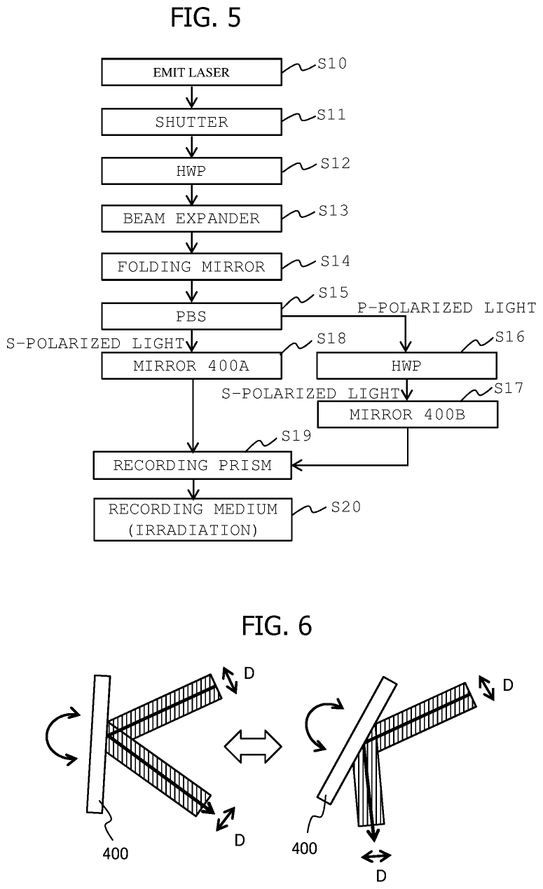

The recording angle is changed by simultaneously moving the two mirrors 400A and 400B in FIG. 4 in symmetric directions (for example, if the mirror 400A is moved in the clockwise direction, the mirror 400B is moved in the counterclockwise direction or the like). The flow of light will be described with reference to FIG. 4 based on a flowchart illustrated in FIG. 5.

In FIG. 5, first, in step S10, light beams are emitted from a laser light source 401; and in step S11, the light beams are incident on a shutter (not illustrated). Then, in step S12, the polarization direction of the light beam that passed when the shutter is opened is controlled by a half-wave plate (HWP) 402 so that a light quantity ratio between P-polarized light and S-polarized light became a desired ratio; and after that, in step S13, the light is enlarged up to the size necessary for recording on the medium surface by a beam expander 403 to obtain parallel light. Then, in step S14, the light is turned back by a folding mirror 404, and in step S15, the light is split into two directions by a polarizing beam splitter (PBS) 405 to generate interference light.

The light beam reflected by the polarizing beam splitter (PBS) 405 becomes S-polarized light, “A” light ray 420A, and the transmitted light beam becomes P-polarized light, “B” light ray 420B. In step S16, the “B” light ray 420B passes through a half-wave plate (HWP) 406, so that the P-polarized light is polarized into S-polarized light. In step S17, the light is reflected by the mirror 400B. On the other hand, the “A” light ray 420A reflected by the polarizing beam splitter (PBS) 405 is reflected by the mirror 400A in step S18. Then, in step S19, the recording prism 500 is irradiated with the respective light beams reflected by the mirrors 400A and 400B. Then, in step S20, the recording medium 510 is irradiated with the respective light beams to allow the two light rays to interfere with each other inside the recording medium 510 to form interference fringes (light intensity distribution), and the recording medium (photopolymer) is exposed by the interference fringes to form a hologram. In addition, reference numeral 408 denotes a uniaxial stage that holds the recording prism 500 and the recording medium 510 and performs position adjustment.

Herein, since the hologram is recorded by irradiating the recording medium with the light reflected from the mirror (emitted from the mirror), the size of the hologram depends on the size (light diameter) of the outgoing light diameter of the mirror.

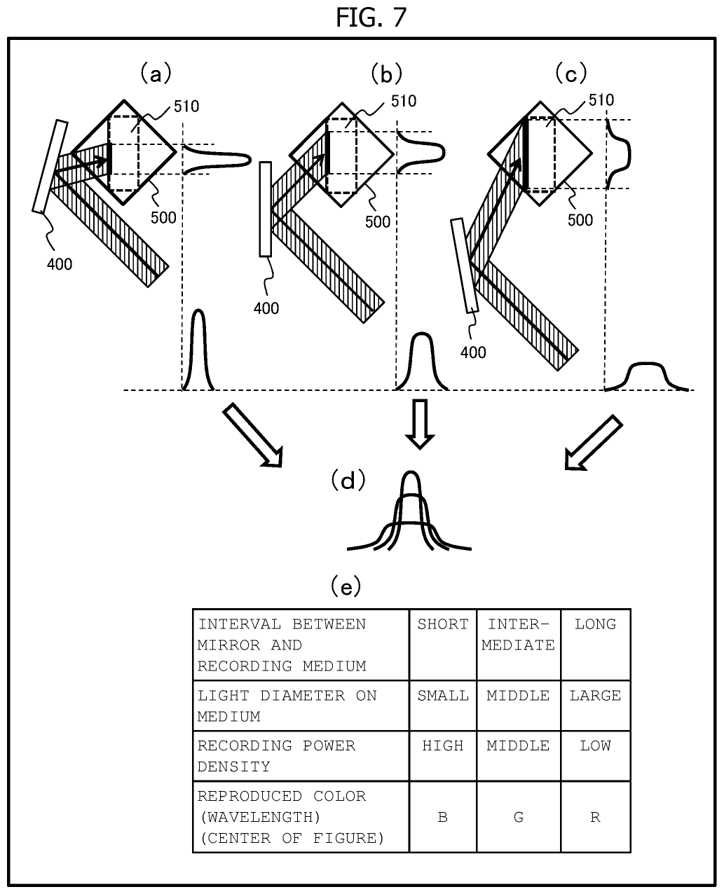

FIG. 6 is a view illustrating a relationship among the mirror angle and the incident light diameter/outgoing light diameter of the mirror. As illustrated in FIG. 6, when the incident light diameter of the mirror 400 is D, the outgoing light diameter is also D, which is constant even if the mirror angle is changed. For this reason, as illustrated in FIG. 7, in a case (a) where the interval between the mirror 400 and the recording medium 510 is short, a case (c) where the interval is long, and a case (b) where the interval is intermediate, the light diameter of outgoing light diameter of the mirror on the recording medium is changed depending on the recording angle. That is, as illustrated in (e), in a case (a) where the interval between the mirror 400 and the recording medium 510 is short, the light diameter on the recording medium becomes small; in a case (b) where the interval between the mirror 400 and the recording medium 510 is intermediate, the light diameter on the recording medium is middle; and in a case (c) where the interval between the mirror 400 and the recording medium 510 is long, the light diameter on the recording medium is large. In addition, the intensity distribution (recording power density) of the recording light on the recording medium is also changed as illustrated in (d) and (e). As described above, when the mirror angle is changed, the power density of light for recording a hologram becomes non-uniform in each recording. Light is guided in the light-guiding plate and diffracted by the hologram to form a reproduced image, and on the other hand, the wavelength at which light can be guided differs depending on the multiple-recording angle of the hologram. It is possible to diffract a wavelength corresponding to blue (B) on the near side of the angle, green (G) in the middle, and red (R) on the long side. By overlapping three colors, white color can be realized. However, when the recording density becomes non-uniform, the diffraction efficiency of some wavelengths (colors) is reduced, and color unevenness such as a color deviation of a color tone as viewed with eyes occurs in the reproduced image.

Herein, the color unevenness is an index indicating the non-uniformity of the color of the entire screen, and partial deviation of a color tone (a color different from a desired color is partially displayed) as viewed with eyes. The color unevenness can be determined by using chromaticity of each point. For example, in a case where white color is desired to be displayed, white color is realized by combining red (R), green (G), and blue (B). On the chromaticity view, white is called a white point, and both the x and y coordinates are about 0.33. If a portion where x and y deviate from the white point is on the screen, the portion is visually recognized as color unevenness.

In addition, since the laser light cannot be used effectively, there is also a problem that the exposure time is increased and the laser light is easily influenced by noise.

As described above, the light-guiding plate of the HMD using the volume-type hologram has a problem of color unevenness as a video display device.

Thus, in the present embodiment, a light-guiding plate using a volume-type hologram with less color unevenness is realized. Hereinafter, the present embodiment will be described.

In the present embodiment, in order to optimize the light flux diameter at the time of recording on the medium, an optical element capable of changing the outgoing angle and the light diameter of the outgoing light is used. As the optical element, a wedge prism mirror (hereinafter, referred to as a wedge prism) having a reflective film (mirror) and having an inclined optical surface is used.

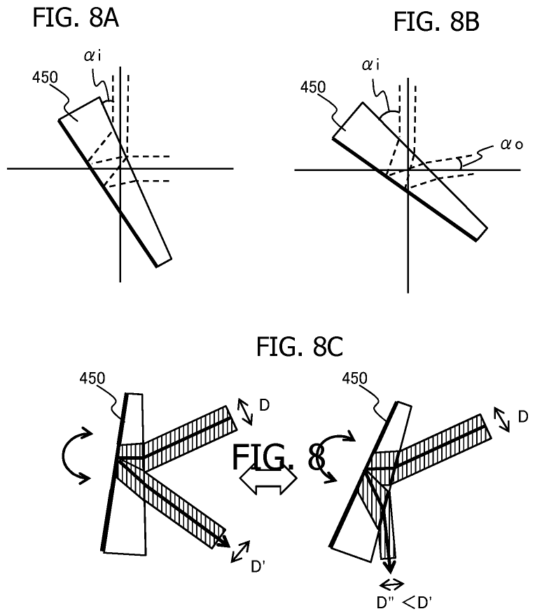

FIGS. 8A to 8C are views describing the basic principle of the wedge prism in the present embodiment. In the wedge prism, since the thickness of the lens is changed according to the incident angle αi and the incident position, in a case of FIG. 8A where the incident angle αi of the incident light on the wedge prism indicated by a broken line is small and a case of FIG. 8B where the incident angle is large, the outgoing angle αo and the diameter of the outgoing light are changed. As described above, by using the internal reflection of the wedge prism mirror, the diameter of the outgoing light flux can be changed according to the incident angle of the light ray. FIG. 8C is a view illustrating the relationship among the mirror angle and the incident light diameter/outgoing light diameter of the mirror. As illustrated in FIG. 8C, when the incident light diameter D of the mirror is set, the outgoing light diameter becomes D′ or D″ according to the mirror angle and depends on the mirror angle.

Therefore, by setting the outgoing light diameter to an arbitrary value according to the mirror angle, the light diameter on the recording medium can be allowed to be substantially constant.

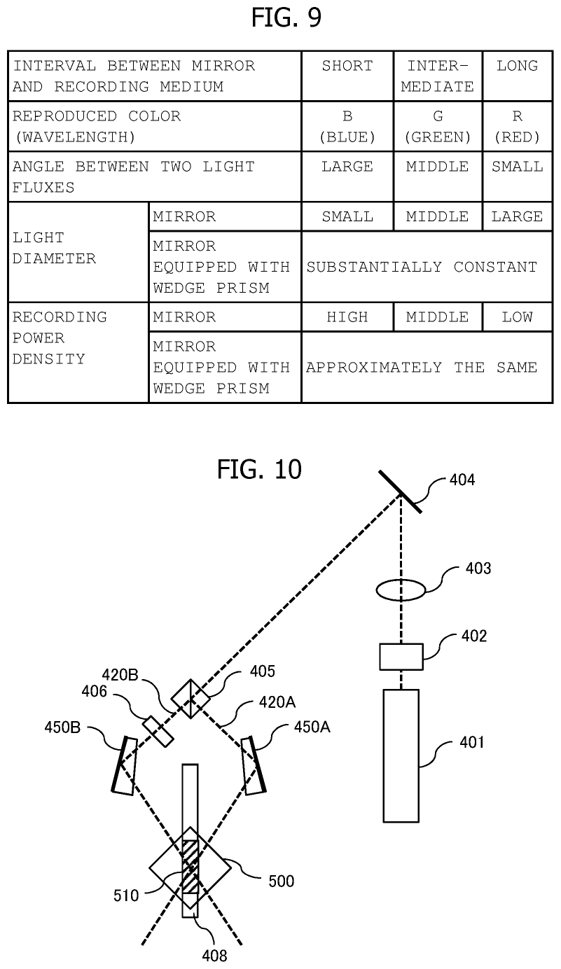

FIG. 9 is a view illustrating differences of the light diameter and the recording power density on the recording medium with respect to the interval between the mirror and the recording medium in the case of a mirror equipped with the wedge prism in the present embodiment and the case of a mirror in the related art. As illustrated in FIG. 9, in the case of the mirror in the related art, the light diameter on the recording medium changes according to the interval between the mirror and the recording medium, but in the case of the mirror equipped with the wedge prism, the light diameter on the recording medium is approximately constant.

In addition, in a case where a mirror is used, the power density of the recording light on the recording medium changes depending on the angle, but by changing the outgoing light of the wedge prism according to the recording angle by using the wedge prism, the volume-type hologram can be recorded with almost the same power density without depending on the angle. In addition, since unnecessary light is reduced, the light use efficiency can be improved. Furthermore, since the light flux diameter on the recording medium can be allowed to be substantially constant, unevenness in diffraction efficiency due to the reproduction wavelength can be reduced, and thus, color unevenness can be reduced.

FIG. 10 is a configuration view of a volume-type hologram recording device equipped with a wedge prism in the present embodiment. In FIG. 10, the same components as those in FIG. 4 are denoted by the same reference numerals, and the description thereof will be omitted. In FIG. 10, by moving and changing wedge prisms 450A and 450B simultaneously in a symmetrical direction, interference occurs in the recording medium 510 to form interference fringes, and the recording medium (photopolymer) is exposed by the interference fringes to form a hologram.

Herein, since the angle relationship between the incidence and the outgoing of the wedge prism is changed, the position where the two light fluxes overlap on the recording medium to form a hologram is different from the position in the case of a mirror. For this reason, in the case of changing from the mirror to the wedge prism, it is necessary to re-adjust the position where the two light fluxes overlap on the stage. The adjustment needs only to be performed once at the time of assembling the device.

In addition, it is necessary to consider the surface reflected light of the wedge prism as an attention point in designing a volume-type hologram manufacturing device equipped with a wedge prism.

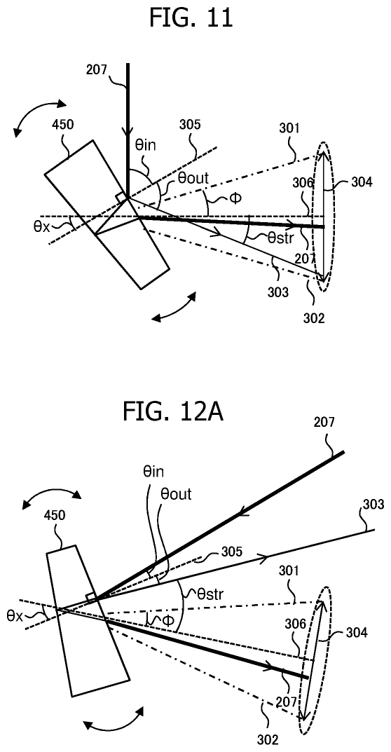

FIG. 11 illustrates a state of propagation of light rays to the wedge prism. Herein, the light ray indicates the center of a light flux. In FIG. 11, when the light flux 207 is incident on the wedge prism 450 at an incident angle θin (herein, 305 indicates a normal line on the incident surface of the wedge prism 450), the light flux is refracted and internally reflected by the wedge prism 450 and propagates through the inside of the recording medium irradiation effective diameter 304 into the recording medium. Herein, the surface reflected light 303 of the wedge prism 450 is reflected at a reflection angle θout=θin according to the law of reflection. As illustrated in FIG. 11, when the surface reflected light propagates through the inside of the recording medium irradiation effective diameter 304 into the recording medium, the surface reflected light 303 becomes stray light, and thus, influences the recording/reproduction of the hologram.

Herein, θstr is the angle between the surface reflected light 303 and the central axis 306 of the storage medium, and ϕ is the angle between the central axis 306 of the storage medium and the light ray 301 or 302 passing through the end face of the storage medium. Angle multiple-recording is performed by changing the recording angle, but the change range of the recording angle is the recording medium irradiation effective diameter 304 and is the angle ±ϕ (ϕ>0) with respect to the central axis 306 of the storage medium.

The surface reflected light 303 can be reduced by a technique called anti-reflection coating (AR coating) or anti-reflection structure (ARS), but it is difficult to completely eliminate the reflected light, and the price of the element will become expensive.

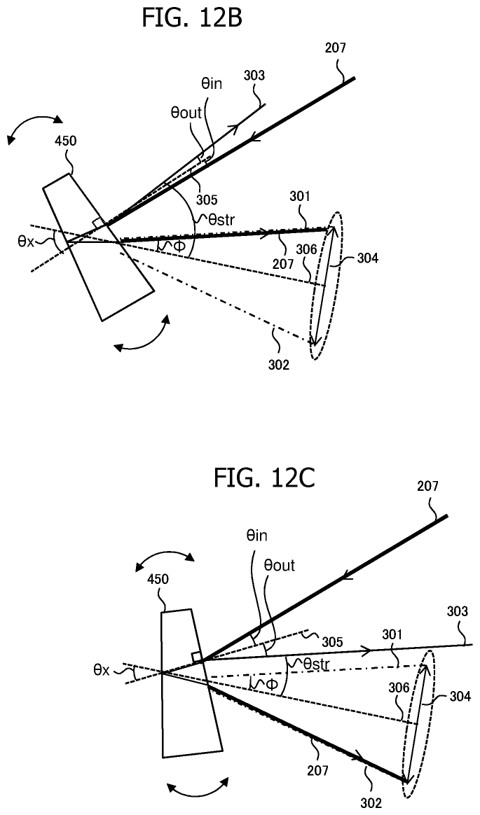

In order to solve this problem, in the present embodiment, the configuration is as illustrated in FIGS. 12A, 12B, and 12C. Herein, FIG. 12A illustrates a case where the outgoing angle of the outgoing light (207) is an angle between +ϕ and −ϕ with respect to the central axis 306 of the storage medium, and FIG. 12B illustrates a case where the outgoing angle is the angle of +ϕ, and FIG. 12C illustrates a case where the outgoing angle is the angle of −ϕ. That is, the following condition is configured to be satisfied in all recording angle ranges.

θstr>ϕ (Mathematical Formula 1)

Accordingly, it is possible to reduce the problem that the surface reflected light 303 of the wedge prism propagates outside the recording medium at all recording angles and the surface reflected light 303 of the wedge prism influences the recording/reproduction of the hologram as the stray light, and it is possible to correct the light flux diameter of the recording light on the recording medium.

In addition, at this time, a configuration in which the stray light propagates to the incident light side as illustrated in FIGS. 12A, 12B, and 12C and a configuration in which the stray light propagates to the outgoing light side as illustrated in FIG. 11 are considered, but in the present embodiment, a configuration in which the stray light propagates to the incident light side is used. That is, the following relationship is configured to be satisfied.

θx−θout>ϕ (Mathematical Formula 2)

Herein, θx is the angle between the normal to the wedge prism incident surface and the central axis of the recording medium.

In addition, Mathematical Formula 2 can also be expressed from the reflection law θin=θout, as follows.

θx−θin>ϕ (Mathematical Formula 3)

In addition, as a method of obtaining the vertex angle of the wedge prism, when the sum of the incident angle and the outgoing angle is in a desired recording angle range, a change in a required light flux diameter in the desired recording angle range is calculated, and a vertex angle equivalent to a change range of the required light flux diameter is set as the vertex angle of the wedge prism. The recording angle range can be arbitrarily set in consideration of the surface reflection of the wedge prism and the like. For example, in the light-guiding plate manufacturing device of FIG. 10, a horizontally-and-vertically symmetrical rhombus is formed by the PBS 405, the recording medium 510, and the two wedge prisms 450A and 450B. For example, if the angle of 90 degrees at which two light rays intersect is based on the sum of the incident angle and the outgoing angle of the wedge prism and the recording angle range is set to ±α deg, the vertex angle at which the change in the required light flux diameter at the time of the recording angle range (90±α deg) calculated by changing the vertex angle and the change in the required light flux diameter in the desired recording angle range calculated above most coincides with each other is set as the vertex angle of the wedge prism.

In addition, it is also necessary to consider the influence of the recording order on the color. That is, since the number M #of multiple-recordings of the hologram is consumed sequentially according to the recording, the hologram is easily influenced by the color recorded first. Herein, in a case where recording is continuously performed in one direction, the recording is performed in the order of continuously recording with the same color multiple times and, after that, continuously recording with other colors. In this case, the number M #of multiple-recordings is first consumed in the same color, and thus, there is a possibility that the number of multiple-recordings is insufficient at the time of recording with another color. For this reason, the same color is not recorded continuously, but each color of RGB is recorded repeatedly in an order, the number of multiple-recordings of each color is consumed on average, and thus, the influence of unintended holograms is reduced. By changing the order of recording, the reproduction colors are different in appearance, and the reproduction light can be approximate to a desired color.

In addition, it is also necessary to consider the exposure time. That is, in a case where the recording is influenced by noise during the recording on the recording medium, an unintended hologram is formed, and thus, the quality of the recording medium is greatly influenced, for example, the reproduction performance is deteriorated or the like. For this reason, the influence of noise can be reduced by shortening the exposure time.

As described above, according to the present embodiment, it is possible to provide a light-guiding plate capable of reducing color unevenness of a reproduced image, and a hologram recording device and a hologram recording method used for the light-guiding plate. In addition, a hologram can be recorded on a recording medium at a desired power density without depending on the angle, and thus, it is possible to reduce color unevenness of the reproduced image. In addition, light can be used effectively, and thus, there is an advantage in that an exposure time is shortened, noise is improved, and the like.

### Second Embodiment

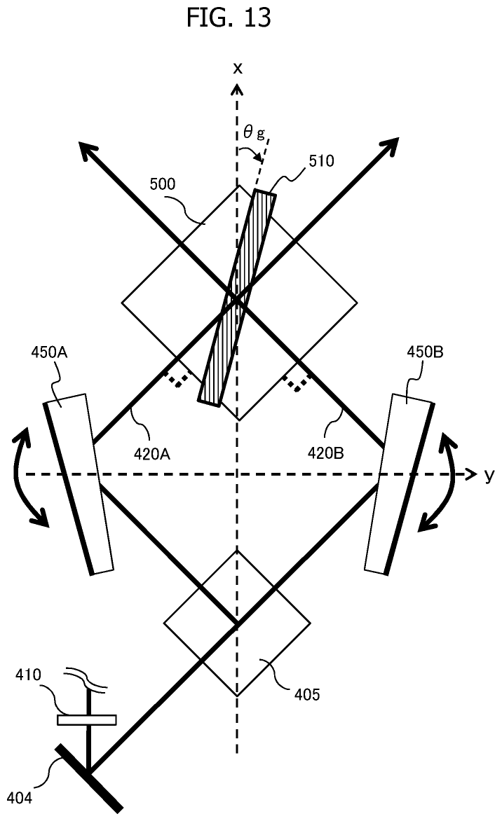

FIG. 13 is a configuration view of a volume-type hologram recording device according to the present embodiment. In FIG. 13, the same components as those in FIG. 10 are denoted by the same reference numerals, and description thereof will be omitted. FIG. 13 is different from FIG. 10 in that the positional relationship among the PBS 405, the recording medium 510, the recording prism 500, and the two wedge prisms 450A and 450B is formed to be a horizontally-and-vertically symmetrical square.

In FIG. 13, a state where the “A” light ray 420A and the “B” light ray 420B are perpendicularly incident on the incident surface of the recording prism 500 is defined as a reference state. In this state, the position/angle adjustment of the PBS 405, the recording prism 500, or the wedge prisms 450A and 450B is performed.

Hereinafter, the adjustment method will be described.

The recording medium 510 is interposed between the recording prisms 500. The recording prism 500 has a square shape as viewed from the top of the hologram recording device. Adjustment of the positions and angles of the recording prism 500 and the wedge prisms 450A and 450B is performed in a reference state in which the “A” light ray 420A and the “B” light ray 420B are perpendicularly incident on the recording prism 500. In the hologram recording device, the “A” light ray 420A and the “B” light ray 420B overlap on the recording medium 510 to form a hologram, and thus, if the positions of the “A” light ray 420A and the “B” light ray 420B are deviated, a region where no hologram is formed is generated. In addition, if the angles of the “A” light ray 420A and the “B” light ray 420B are deviated, an angle deviation of the formed hologram occurs. Furthermore, if the angle of the recording prism 500 is deviated, a desired hologram cannot be recorded. For this reason, it is necessary to adjust the positions and angles of the “A” light ray 420A, the “B” light ray 420B, and the recording prism 500.

In the reference state, the “A” light ray 420A and the “B” light ray 420B are incident on the incident surface of the recording prism 500 at 90 degrees. Since the “A” light ray 420A and the “B” light ray 420B are perpendicularly incident on the surface of the recording prism 500, the angle of surface reflection is also perpendicular. In this case, the surface reflections of the “A” light ray 420A and the “B” light ray 420B return to the respective returning optical paths and coincide in the optical path before the incident light of the PBS 405. For this reason, an aperture 410 is added to the optical path before the PBS 405 in the reference state, and the positions and the angles of the PBS 405, the wedge prisms 450A and 450B, or the recording prism 500, and the recording medium 510 are adjusted so that surface reflected lights of the “A” light ray 420A and the “B” light ray 420B substantially coincide with each other at the aperture position.

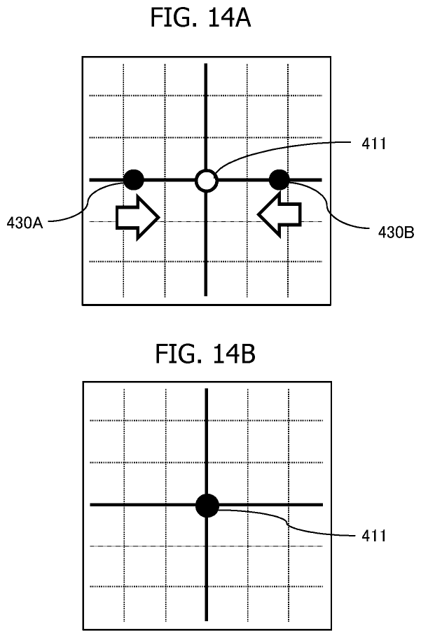

FIGS. 14A and 14B are explanatory views of a position/angle adjusting method between the PBS or the wedge prism or the recording prism and the recording medium in the present embodiment. FIG. 14A illustrates the return lights of the surface reflection of the “A” light ray 420A and the “B” light ray 420B on the recording prism 500 at the aperture position before the adjustment, and the return light 430A of the “A” light ray 420A and the return light 430B of the “B” light ray 420B are located on the right and left in the figure. On the contrary, FIG. 14B illustrates the return light after the adjustment, and the return lights of the “A” light ray 420A and the “B” light ray 420B coincide with each other at one point of the pinhole (aperture) 411.

In this manner, the position and angle of the PBS 405 or the wedge prisms 450A and 450B or the recording prism 500 and the recording medium 510 may be adjusted so that the return lights of the “A” light ray 420A and the “B” light ray 420B coincide with each other at one point of the pinhole (aperture) 411.

In addition, at the time of adjustment, the light flux diameters of the “A” light ray 420A and the “B” light ray 420B are reduced by the aperture and allowed to be incident on the position where the light rays do not hit the recording medium, so that unnecessary exposure on the recording medium 510 is prevented. In addition, the adjustment is performed by moving and matching the x-axis, the y-axis, the z-axis, and the rotation stage arranged below the wedge prisms 450A and 450B or the recording prism 500.

As described above, according to the present embodiment, the positional relationship among the PBS 405, the recording medium 510, the recording prism 500, and the two wedge prisms 450A and 450B is arranged so as to form a horizontally-and-vertically symmetrical square, and the “A” light ray 420A and the “B” light ray 420B are configured to be perpendicularly incident on the recording prism 500, the position of the PBS 405 or the wedge prisms 450A and 450B or the recording prism 500 and the recording medium 510 can be adjusted by using the return light. The adjustment needs to be performed every time the recording medium is installed.

In addition, described above, the positional relationship among the PBS 405, the recording medium 510, the recording prism 500, and the two wedge prisms 450A and 450B is arranged so as to form a horizontally-and-vertically symmetrical square, and the method of adjusting the positions and the angles can be applied by replacing the wedge prisms 450A and 450B with the mirrors 400A and 400B of the related art illustrated in FIG. 4. At this time, there is no effect of reducing the color unevenness by the wedge prisms, but there is an effect that the adjustment of the positions and the angles can be easily realized.

Although the embodiments have been described above, the present invention is not limited to the above-described embodiments but includes various modifications. For example, the above-described embodiments have been described in detail in order to describe the present invention for the easy understanding, and the embodiments are not necessarily limited to those having all the configurations described above. In addition, a portion of the configurations of one embodiment can be replaced with the configurations of another embodiment, and the configurations of one embodiment can be added to the configurations of another embodiment. In addition, for a portion of the configuration of each embodiment, it is possible to add, delete, or replace other configurations.

What is claimed is:

1. A light-guiding plate having a light diffractive portion that diffracts incident light by multiple-recorded hologram,
wherein the light diffractive portion has at least two or more regions and diffracts a different wavelength depending on each region when a certain light ray is incident, and power densities of light output diffracted for the different wavelengths are the same.

2. The light-guiding plate according to claim 1, wherein the light diffractive portion is used as an outgoing coupler that converts light propagating inside the light-guiding plate to light emitted outside the light-guiding plate.

3. A hologram recording device for producing a hologram that diffracts incident light, comprising:
a laser light source;
a first half-wave plate that controls a polarization direction of a light beam emitted from the laser light source;
a polarizing beam splitter that reflects S-polarized light to emit the S-polarized light as an “A” light ray and transmits P-polarized light to emit the P-polarized light as a “B” light ray with respect to the light beam passing through the first half-wave plate, and splits the light beam in two directions;
a first wedge prism mirror that reflects the “A” light ray;
a second half-wave plate that polarizes the “B” light ray into S-polarized light;
a second wedge prism mirror that reflects the S-polarized light polarized by the second half-wave plate; and
a recording medium which is irradiated with a light ray reflected by the first wedge prism mirror and a light ray reflected by the second wedge prism mirror.

4. The hologram recording device according to claim 3, wherein a positional relationship among the polarizing beam splitter, the recording medium, the first wedge prism mirror, and the second wedge prism mirror forms a horizontally-and-vertically symmetrical square.

5. A hologram recording method for producing a hologram that diffracts incident light, the method comprising:
splitting a light beam emitted from a laser light source into two S-polarized lights;
reflecting the two S-polarized lights by first and second wedge prism mirrors, respectively; and
irradiating a recording medium with a first light ray reflected by the first wedge prism mirror and a second light ray reflected by the second wedge prism mirror,
wherein the first and second light rays interfere with each other in the recording medium to form interference fringes, and the recording medium is exposed by the interference fringes to form a hologram.

6. The hologram recording method according to claim 5,
wherein the positional relationship among the element that splits the light beam into the two S-polarized lights, the recording medium, and the first and second wedge prism mirrors forms a horizontally-and-vertically symmetrical square, and
wherein position adjustment of an element configured so that the first and second light rays are perpendicularly incident on the recording prisms interposing the recording medium and splits the light beam into the two S-polarized lights by using return lights from the recording prisms, the recording medium, and the first and second wedge prism mirrors are performed.
